(19) United States
(12) Patent Application Publication
(10) Pub. No.: US 2011/0237313 A1
(43) Pub. Date: Sep. 29, 2011

(54) MOBILE TERMINAL APPARATUS

(75) Inventors: Hiroyuki Takita, Kawasaki (JP); Yoshifumi Kajiwara, Kawasaki (JP); Haruyoshi Yada, Kawasaki (JP); Kenta Sugimori, Kawasaki (JP); Hiroshi Kubo, Kawasaki (JP)

(73) Assignee: FUJITSU LIMITED, Kawasaki-shi (JP)

(21) Appl. No.: 13/049,325

(22) Filed: Mar. 16, 2011

(30) Foreign Application Priority Data
Mar. 26, 2010 (JP) 2010-72099

(51) Int. Cl. H04M 1/00

(52) U.S. Cl. 455/575.4

(57) ABSTRACT

A mobile terminal apparatus includes a first casing that is provided with an operation portion; a second casing that is disposed so as to oppose a front surface of the first casing in which the operation portion is provided, the second casing being rotatable parallel to the front surface around a center positioned in a portion other than the operation portion of the front surface; and a protruding portion that is formed between the operation portion and the center on a surface of either the first casing or the second casing, the surface with the protruding portion opposing the other casing, the protruding portion protrudes toward the other casing by a height greater than or equal to a gap provided between the casings at the center.

### CROSS-REFERENCE TO RELATED APPLICATIONS

This application is based upon and claims the benefit of priority from the prior Japanese Patent Application No. 2010-72099 filed on Mar. 26, 2010, the entire contents of which are incorporated herein by reference.

### FIELD

The embodiment discussed herein is related to a mobile terminal apparatus.

### BACKGROUND

Mobile terminal apparatuses such as mobile phone apparatuses may have fixed casings provided with operation portions and movable casings provided with components such as liquid crystal displays. Recently, for example, as Japanese Laid-open Patent Publication Nos. 2004-187186 and 2008-66763 disclose, there have been mobile terminal apparatuses in which movable casings are rotated parallel to fixed casings.

Referring to FIGS. 9 and 10, a rotating-type mobile terminal apparatus will be described. FIGS. 9 and 10 are perspective views illustrating the appearances of a rotating-type mobile phone apparatus 200. As illustrated in FIG. 9, the mobile phone apparatus 200 includes a movable casing 210 and a fixed casing 220. The movable casing 210 includes a liquid crystal display 211 that displays a variety of information. The fixed casing 220 includes an operation portion 221 in which keys such as a multi-function keys, an Enter key, dial keys, and a tenkey are arranged.

In an example of the mobile phone apparatus 200 as illustrated in FIG. 9, the movable casing 210 and the fixed casing 220 are connected to each other with a connecting portion (not illustrated). The connecting portion rotatably connects the movable casing 210 to the fixed casing 220. In more detail, the movable casing 210 is rotatably connected to the fixed casing 220 with the connecting portion (not illustrated) while remaining parallel to the fixed casing 220.

FIG. 10 illustrates a rotated state in which the movable casing 210 has been rotated. That is, in an example illustrated in FIG. 10, the movable casing 210 has been rotated and, as a result, a longitudinal direction of the movable casing 210 is perpendicular to that of the fixed casing 220. With the rotating-type mobile phone apparatus 200, the ease of watching the liquid crystal display 211 has been improved. For example, a user may use the display portion 211 for watching broadcasting in a wider screen by rotating the movable casing 210. The user may watch terrestrial digital broadcasting or one-segment broadcasting while holding the fixed casing 220 of the mobile phone apparatus 200.

However, the above-described rotating-type mobile phone apparatus 200 has a problem in that the casings of the mobile phone apparatus 200 are vulnerable to damage. Referring to FIG. 9, when the movable casing 210 is rotated, one end of the movable casing 210 may contact the fixed casing 220 during the rotation. In so doing, the movable casing 210 may damage the fixed casing 220.

More details will be described with reference to FIG. 11. FIG. 11 is a schematic diagram illustrating a sectional view of the mobile phone apparatus 200 taken along I-I line of FIG. 9. As illustrated in FIG. 11, when the movable casing 210 is rotated, one end of the movable casing 210 may move down toward the fixed casing 220. This may remove a gap between the movable casing 210 and the fixed casing 220. When the movable casing 210 is rotated in this state, one end of the movable casing 210 may damage a surface of the fixed casing 220 in which the operation portion 221 is provided.

### SUMMARY

According to an aspect of the invention, a mobile terminal apparatus includes a first casing that is provided with an operation portion; a second casing that is disposed so as to oppose a front surface of the first casing in which the operation portion is provided, the second casing being rotatable parallel to the front surface around a center positioned in a portion other than the operation portion of the front surface; and a protruding portion that is formed between the operation portion and the center on a surface of either the first casing or the second casing, the surface with the protruding portion opposing the other casing, the protruding portion protrudes toward the other casing by a height greater than or equal to a gap provided between the casings at the center.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a perspective view illustrating an example of the appearance of the front surface side of the mobile phone apparatus according to the present embodiment;

FIG. 2 illustrates an example of the appearance of the front surface side of the mobile phone apparatus according to the present embodiment in a rotated state;

FIG. 3 is an exploded perspective view illustrating an example of a configuration of the mobile phone apparatus according to the present embodiment;

FIG. 4 illustrates an enlarged plan view of the swing seat according to the present embodiment;

FIG. 5 is a schematic diagram that illustrates a sectional view of the swing seat taken along II-II line of FIG. 4;

FIG. 6 is a schematic diagram illustrating a sectional view of part of the mobile phone apparatus taken along III-III line in FIG. 1;

FIGS. 7A to 7E are plan views illustrating the swing operation of the mobile phone apparatus according to the present embodiment;

FIGS. 8A to 8E are schematic diagrams illustrating sectional views of the swing seat and the contact portion of the mobile phone apparatus taken along IV-IV line of FIGS. 7A to 7E;

FIG. 9 is perspective views illustrating the appearances of a rotating-type mobile phone apparatus;

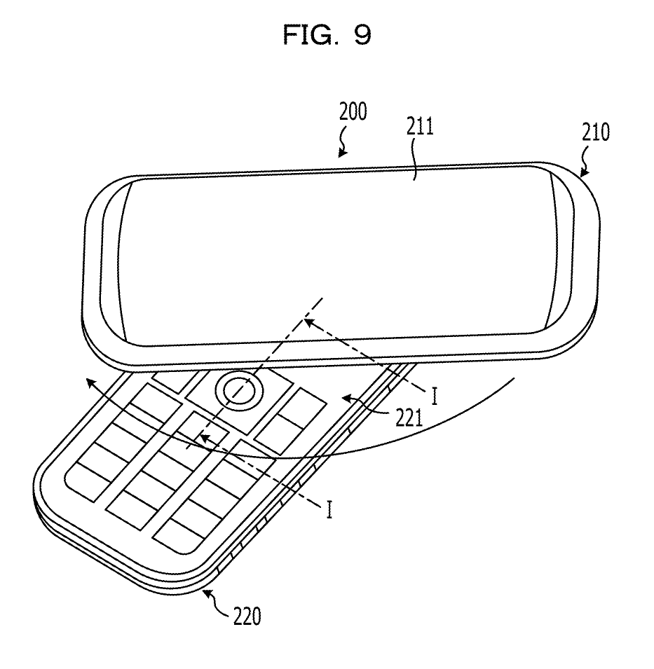

FIG. 10 illustrates a rotated state in which the movable casing has been rotated; and

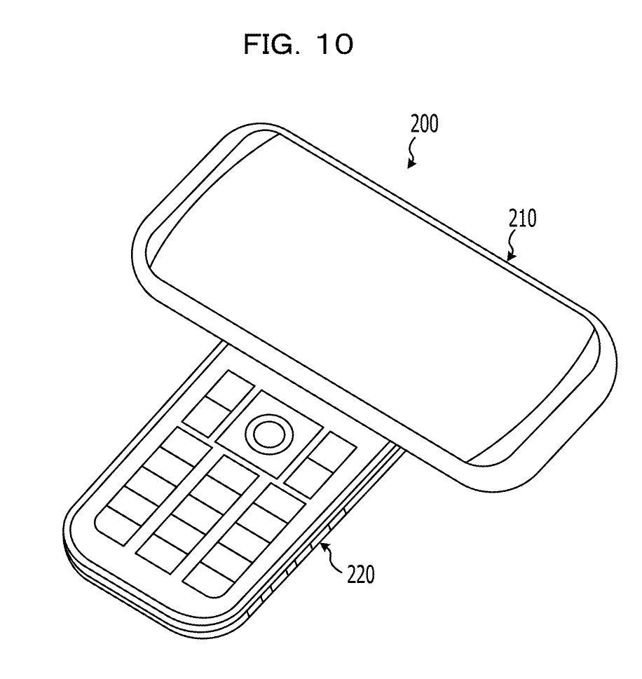

FIG. 11 is a schematic diagram illustrating a sectional view of the mobile phone apparatus taken along I-I line of FIG. 9.

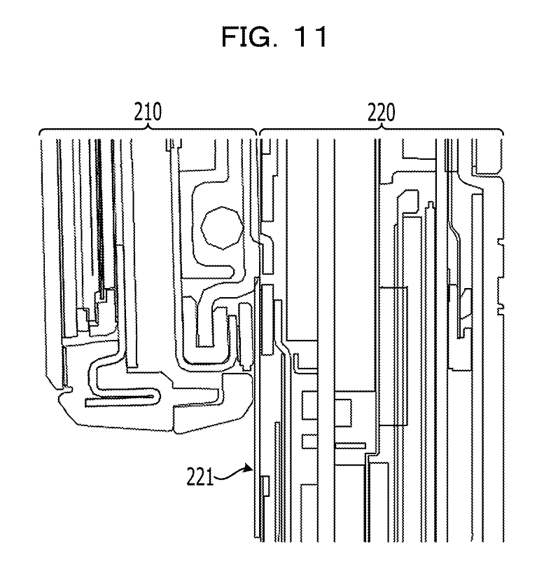

### DESCRIPTION OF EMBODIMENTS

An embodiment of a mobile terminal apparatus disclosed herein will be described in detail below with reference to the drawings. The present embodiment is not intended to limit the mobile terminal apparatus disclosed herein to a mobile phone apparatus. For example, the technology of the mobile terminal apparatus disclosed herein is also applicable to other mobile terminal apparatuses such as personal digital assistants (PDAs).

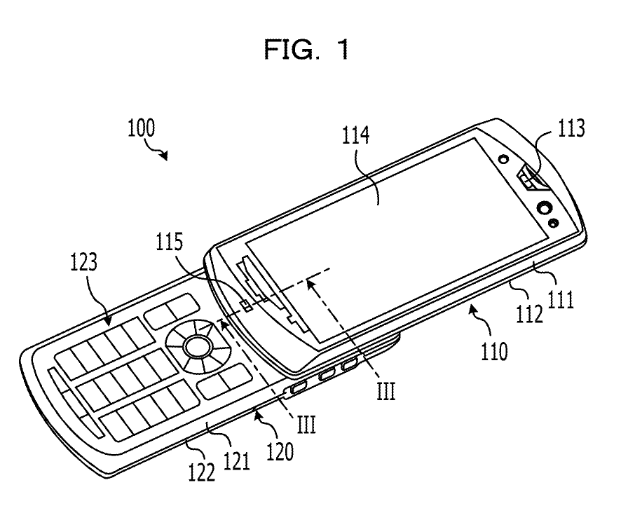

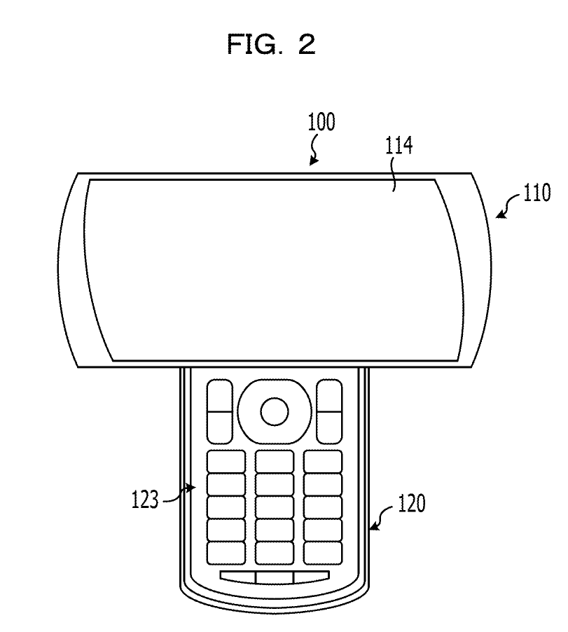

Referring to FIGS. 1 and 2, the appearances of a mobile phone apparatus 100 according to the present embodiment will be described. FIG. 1 is a perspective view illustrating an example of the appearance of the front surface side of the mobile phone apparatus 100 according to the present embodiment. As illustrated in FIG. 1, the mobile phone apparatus 100 according to the present embodiment includes a movable casing 110 and a fixed casing 120.

In the present embodiment, surfaces of the movable casing 110 and the fixed casing 120 may be referred to as follows. That is, a surface of the movable casing 110 that includes a liquid crystal display 114 may be referred to as a “front surface,” a surface of the movable casing 110 that is opposite to the surface of the movable casing 110 that includes the liquid crystal display 114 may be referred to as a “rear surface,” a surface of the fixed casing 120 that includes operation keys may be referred to as a “front surface,” and a surface of the fixed casing 120 that is opposite to the surface of the fixed casing 120 that includes operation keys may be referred to as a “rear surface.”

The movable casing 110 and the fixed casing 120 are movably connected to each other with a connecting portion (not illustrated). The connecting portion includes a sliding mechanism and a rotating mechanism that slidably connects the movable casing 110 to the fixed casing 120 and rotatably connects the movable casing 110 to the fixed casing 120. FIG. 1 illustrates an open state where the movable casing 110 has been slid out and overlaps the fixed casing 120 with a minimum overlapping area. FIG. 1 illustrates a state in which the movable casing 110 is not rotated. When not in use, the slide-type mobile phone apparatus 100 as described above is in a closed state where the movable casing 110 overlaps the fixed casing 120. To operate the keys provided in the fixed casing 120, the movable casing 110 is slid relative to the fixed casing 120 in a longitudinal direction in order to set the mobile phone apparatus 100 in the open state.

As illustrated in FIG. 1, the movable casing 110 includes a front outer case 111 and a rear outer case 112. The front outer case 111 defines an outer surface of the mobile phone apparatus 100 in the closed state. The rear outer case 112 is positioned on the inner side of the mobile phone apparatus 100 in the closed state.

The front outer case 111 includes components such as a receiver portion 113 that receives speech and sounds during a call, the liquid crystal display 114 that displays a variety of information, and an opening 115 that penetrates through the front outer case 111. The opening 115 is a through hole that communicates with a microphone (not illustrated) provided on the front surface side inside the movable casing 110. That is, speech uttered by a user reaches the inside of the movable casing 110 through the opening 115 and is picked up by the microphone.

As illustrated in FIG. 1, the fixed casing 120 includes a front outer case 121 and a rear outer case 122. The front outer case 121 is positioned on the inner side of the mobile phone apparatus 100 in the closed state. The rear outer case 122 defines an outer surface of the mobile phone apparatus 100 in the closed state. The front outer case 121 includes a key pad 123, in which operation keys such as a multi-function keys, an Enter key, dial keys and a tenkey are provided.

FIG. 2 illustrates an example of the appearance of the front surface side of the mobile phone apparatus 100 according to the present embodiment in a rotated state. As illustrated in FIG. 2, when the movable casing 110 is rotated, a longitudinal direction of the movable casing 110 is perpendicular to that of the fixed casing 120. Since the movable casing 110 of the mobile phone apparatus 100 is configured to be rotatable, the ease of watching the liquid crystal display 114 may be improved.

Rotation of the movable casing 110 according to the present embodiment ranges from a non-rotated state illustrated in FIG. 1 to a rotated state illustrated in FIG. 2. More specifically, the movable casing 110 may be rotated from the non-rotated state, in which the longitudinal direction of the movable casing 110 is parallel to that of the fixed casing 120, to the rotated state, in which the longitudinal direction of the movable casing 110 is perpendicular to that of the fixed casing 120. In other words, the movable casing 110 may rotate 90° relative to the fixed casing 120 from the non-rotated state illustrated in FIG. 1.

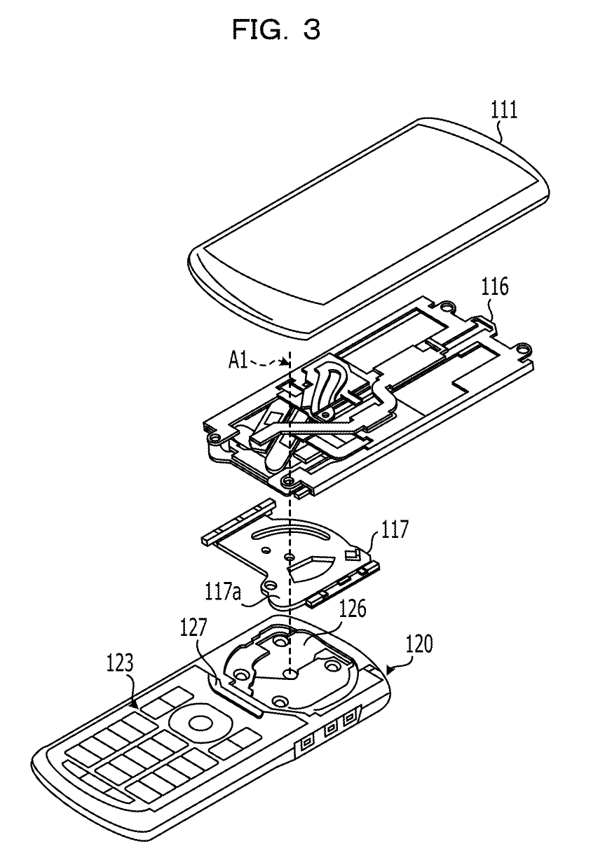

Referring to FIG. 3, an internal structure of the mobile phone apparatus 100 according to the present embodiment will be described. FIG. 3 is an exploded perspective view illustrating an example of a configuration of the mobile phone apparatus 100 according to the present embodiment. As illustrated in FIG. 3, a rail plate 116 and a swing plate 117 are mounted on the movable casing 110. The rail plate 116 slides together with the movable casing 110 in an integral manner along a groove in a convex portion formed in a peripheral portion of the front outer case 121 of the fixed casing 120. The swing plate 117 is engaged with the base plate 126 of the fixed casing 120. For example, a central portion of the swing plate 117 is engaged with a central portion of the base plate 126. The swing plate 117 is rotated together with the movable casing 110 in an integrated manner around the portion of the swing plate 117 that is engaged with the base plate 126. At this time, the swing plate 117 slides along the slide groove of the base plate 126 in order to rotate together with the movable casing 110 in an integrated manner. The swing plate 117 has a contact portion 117a formed therein that protrudes toward the key pad 123. The contact portion 117a contacts a swing seat 127, which will be described below.

The fixed casing 120 according to the present embodiment includes the swing seat 127. The swing seat 127 is disposed between the key pad 123 and an engaging portion of the swing plate 117 and the base plate 126 on an operation surface of the fixed casing 120 where the key pad 123 is disposed. In other words, the swing seat 127 is disposed between the key pad 123 and axis A1 around which the swing plate 117 and the base plate 126 rotate. The swing seat 127 includes a protruding portion formed thereon that protrudes by a height greater than or equal to a gap along axis A1 between the swing plate 117 and the engaging portion of the base plate 126.

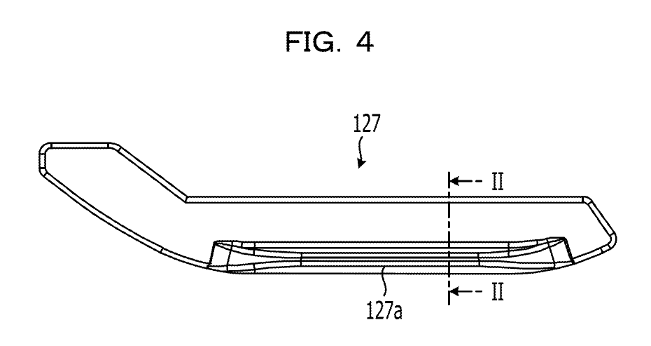

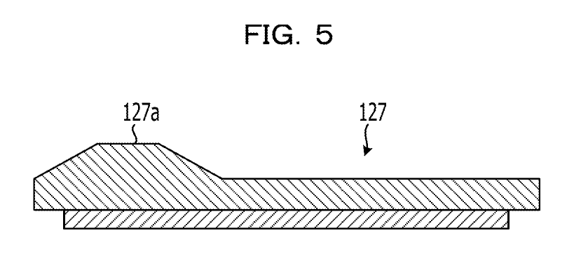

Referring to FIGS. 4 and 5, the swing seat 127 will be described in more detail. FIG. 4 illustrates an enlarged plan view of the swing seat 127 according to the present embodiment. FIG. 4 illustrates the enlarged view of the swing seat 127 seen from the front surface of the fixed casing 120 illustrated in FIG. 3. FIG. 5 is a schematic diagram that illustrates a sectional view of the swing seat 127 taken along II-II line of FIG. 4. As illustrated in FIGS. 4 and 5, the swing seat 127 includes a protruding portion 127a formed thereon. The protruding portion 127a protrudes toward the contact portion 117a of the swing plate 117 by a height greater than or equal to the gap along axis A1 as illustrated in FIG. 3 between the swing plate 117 and the engaging portion of the base plate 126. That is, when the swing plate 117 is rotated, the contact portion 117a moves while contacting the protruding portion 127a of the swing seat 127.

Since the contact portion 117a of the swing plate 117 according to the present embodiment contacts the protruding portion 127a, the movable casing 110 may be moved up toward a direction away from the fixed casing 120. More specifically, as illustrated in FIG. 3, the swing plate 117 is mounted on the front outer case 111 of the movable casing 110 together with the rail plate 116 in an integrated manner. That is, the contact portion 117a of the swing plate 117 contacts the protruding portion 127a of the swing seat 127 mounted on the fixed casing 120. This may prevent the movable casing 110 from contacting the fixed casing 120. The contact portion 117a of the swing plate 117 may cause the movable casing 110 to be tilted in a direction away from the fixed casing 120 within a range from a position where the swing plate 117 is mounted to a position where the key pad 123 is mounted.

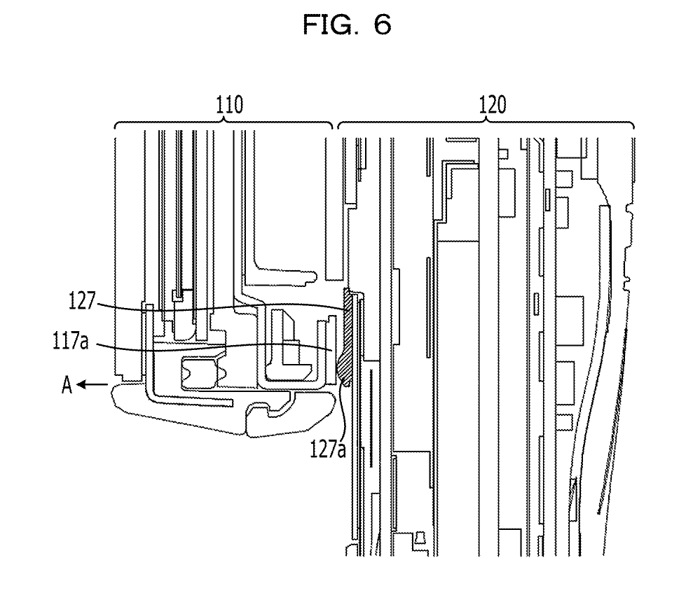

FIG. 6 is a schematic diagram illustrating a sectional view of part of the mobile phone apparatus 100 taken along III-III line in FIG. 1. As described in FIG. 6, the contact portion 117a of the swing plate 117 contacts the protruding portion 127a of the swing seat 127. As a result, the swing plate 117 may cause the movable casing 110 to be moved up in the direction of arrow A, which is a direction away from the fixed casing 120.

In the mobile phone apparatus 100 according to the present embodiment, removal of a gap between the movable casing 110 and the fixed casing 120 may be prevented. Thus, even when the movable casing 110 is being rotated, damage to the operation surface of the fixed casing 120, which may otherwise be caused by one end of the movable casing 110, may be prevented.

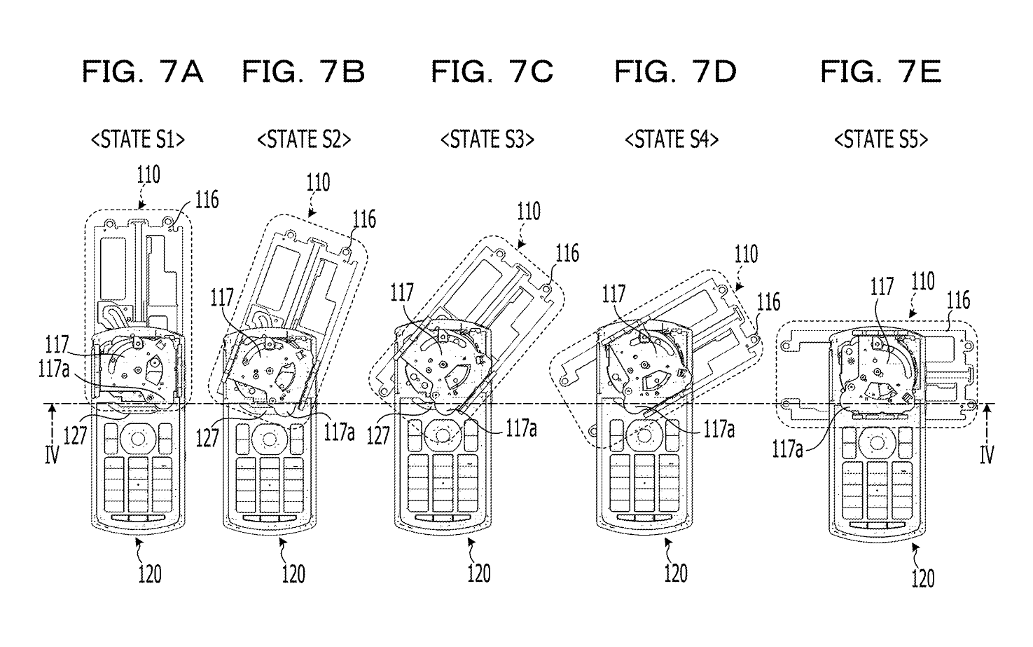

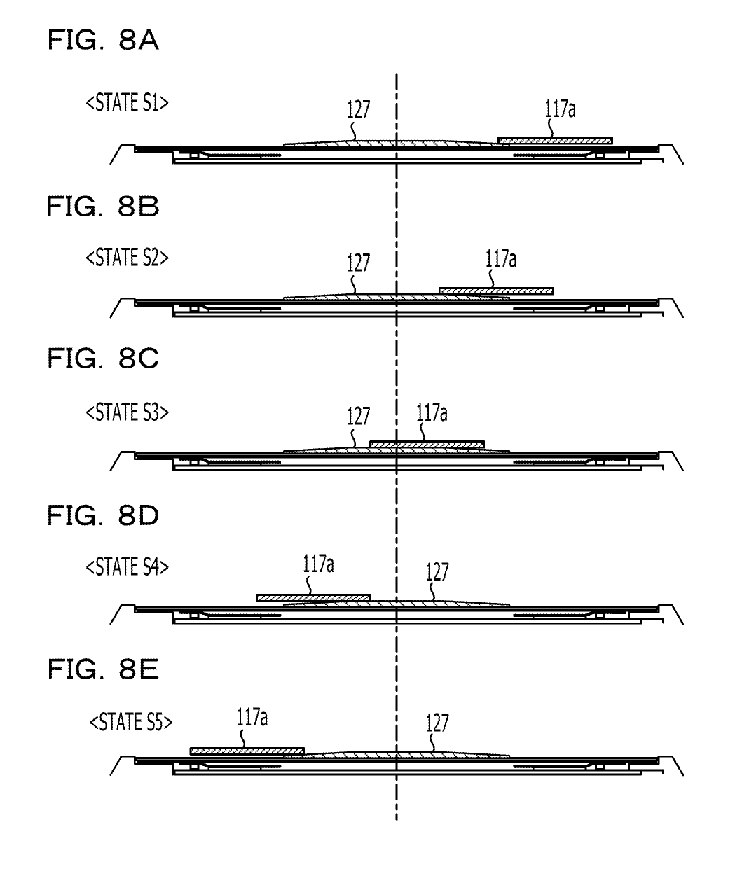

Referring to FIGS. 7A to 7E and 8A to 8E, a swing operation of the mobile phone apparatus 100 according to the present embodiment will be described. FIGS. 7A to 7E are plan views illustrating the swing operation of the mobile phone apparatus 100 according to the present embodiment. FIGS. 8A to 8E are schematic diagrams illustrating sectional views of the swing seat 127 and the contact portion 117a of the mobile phone apparatus 100 taken along IV-IV line of FIGS. 7A to 7E. FIG. 7A illustrates state S1, in which the movable casing 110 has not been rotated. In FIGS. 7A to 7E, from left to right, the movable casing 110 of the mobile phone apparatus 100 is rotated by increasingly greater amounts. FIG. 7E illustrates state S5, in which the movable casing 110 has been rotated 90° relative to the fixed casing 120. States S1 to S5 illustrated in FIGS. 8A to 8E correspond to states S1 to S5 illustrated in FIGS. 7A to 7E. The dashed line drawn across central portions of FIGS. 8A to 8E indicates a central portion of the swing seat 127.

As illustrated in state S1 in FIG. 7A, even when the movable casing 110 has not been rotated, the contact portion 117a of the swing plate 117 contacts the protruding portion 127a of the swing seat 127. More specifically, as illustrated in state S1 in FIG. 8A, at least part of the contact portion 117a of the swing plate 117 contacts the protruding portion 127a of the swing seat 127.

As illustrated in states S2 to S4 in FIGS. 7B to 7D, when the swing plate 117 is rotated together with the movable casing 110 in an integrated manner, the contact portion 117a moves while contacting the protruding portion 127a of the swing seat 127. More specifically, as illustrated in states S2 to S4 in FIGS. 8B to 8D, the contact portion 117a of the swing plate 117 moves on the protruding portion 127a while partly or entirely contacting the protruding portion 127a.

As illustrated in state S5 in FIG. 7E, even when the movable casing 110 has been rotated 90° relative to the fixed casing 120, the contact portion 117a of the swing plate 117 contacts the protruding portion 127a of the swing seat 127. More specifically, as illustrated in state S5 in FIG. 8E, at least part of the contact portion 117a of the swing plate 117 contacts the protruding portion 127a of the swing seat 127.

The contact portion 117a of the swing plate 117 constantly contacts the protruding portion 127a of the swing seat 127. This prevents the contact portion 117a from being jammed due to a height difference between the front outer case 121 and the protruding portion 127a while the swing plate 117 is rotated. Thus, the contact portion 117a may smoothly move on the protruding portion 127a. The movable casing 110 may smoothly move in the mobile phone apparatus 100 according to the present embodiment.

As illustrated in FIGS. 8A to 8E, the protruding portion 127a of the swing seat 127 is formed so as to gradually decrease in height in directions from the center to the edges. More specifically, the height of an area of the protruding portion 127a that contacts the contact portion 117a gradually increases in the following order: an open state illustrated as state S1 in FIG. 8A, state S2 illustrated in FIG. 8B, and state S3 illustrated in FIG. 8C. The height of an area of the protruding portion 127a that contacts the contact portion 117a gradually decreases in the following order: state S3 illustrated in FIG. 8C, state S4 illustrated in FIG. 8D, and state S5 illustrated in FIG. 8E. That is, the protruding portion 127a smoothly protrudes upward with respect to a moving direction of the contact portion 117a.

The swing seat 127 according to the present embodiment may assist the movable casing 110 to be rotated over part of the rotating range. For example, the swing seat 127 may assist the movable casing 110 to be rotated from state S3 as illustrated in FIG. 7C to state S5 as illustrated in FIG. 7E. A force that acts on the contact portion 117a of the swing plate 117 is directed so as to cause the contact portion 117a to contact the protruding portion 127a. Therefore, when the state of the contact portion 117a changes from state S3 as illustrated in FIG. 7C to state S5 as illustrated in FIG. 7E, the contact portion 117a is moved toward a position where the height of the protruding portion 127a is lower. Accordingly, the user of the mobile phone apparatus 100 according to the present embodiment may easily rotate the movable casing 110 from state S3 to state S5. Likewise, the swing seat 127 may assist the movable casing 110 to be rotated from state S3 as illustrated in FIG. 7C to state S1 as illustrated in FIG. 7A. Accordingly, the user of the mobile phone apparatus 100 according to the present embodiment may easily rotate the movable casing 110 from state S3 to state S1.

In the mobile phone apparatus 100 according to the present embodiment, the swing seat 127 that includes the protruding portion 127a protruding toward the contact portion 117a of the swing plate 117 is mounted on the fixed casing 120. When the movable casing 110 is rotated, the contact portion 117a of the swing plate 117 moves while contacting the protruding portion 127a. By doing this, the swing plate 117 may cause the movable casing 110 to be tilted in a direction away from the fixed casing 120. In the mobile phone apparatus 100 according to the present embodiment, removal of the gap between the movable casing 110 and the fixed casing 120 may be prevented. Thus, even when the movable casing 110 is being rotated, damage to the operation surface of the fixed casing 120, which may otherwise be caused by one end of the movable casing 110, may be prevented.

When there is no gap provided between the movable casing and the fixed casing, the movable casing may be rotated while one end thereof contacts an operation portion of the fixed casing. As a result, the end of the movable casing may press the operating portion. A problem may occur in that an operation key that the user does not intend to press is pressed when the movable casing is rotated. In the mobile phone apparatus 100 according to the present embodiment, since the swing plate 117 may cause the movable casing 110 to be moved up in a direction away from the fixed casing 120, such accidental pressing of an operation key may be prevented even when the movable casing 110 is rotated.

The protruding portion 127a of the swing seat 127 according to the present embodiment is at least formed in a position corresponding to a path of the rotation of the contact portion 117a of the swing plate 117. In other words, the contact portion 117a of the swing plate 117 contacts the protruding portion 127a of the swing seat 127 over the entire range of the path of the rotation. In the mobile phone apparatus 100 according to the present embodiment, when the swing plate 117 is rotated, a situation in which the contact portion 117a is jammed due to a height difference between the front outer case 121 and the protruding portion 127a may be prevented from occurring. As a result, the movable casing 110 may be smoothly moved in the mobile phone apparatus 100 according to the present embodiment.

The protruding portion 127a of the swing seat 127 according to the present embodiment is formed, for example as illustrated in FIG. 8A, so as to gradually decrease in height along directions from the center to the edges. This may assist the movable casing 110 to be rotated in part of the rotating range in the mobile phone apparatus 100 according to the present embodiment. Accordingly, the user of the mobile phone apparatus 100 according to the present embodiment may easily rotate the movable casing 110 in part of the rotating range.

In an example of the present embodiment that has been illustrated, the swing seat 127 is disposed on the front surface of the fixed casing 120. Alternatively, the front surface of the fixed casing 120 itself may protrude so as to have a shape similar to that of the protruding portion 127a described above.

In an example of the present embodiment that has been illustrated, the contact portion 117a of the swing plate 117 moves while contacting the protruding portion 127a of the swing seat 127. Alternatively, part of the rail plate 116 or part of the front outer case 111 may move while contacting the protruding portion 127a of the swing seat 127.

In an example of the present embodiment that has been illustrated, the swing seat 127 is disposed on the front surface of the fixed casing 120. Alternatively, the swing seat 127 may be disposed on the movable casing 110. For example, the contact portion 117a described above may be formed so as to protrude toward the front surface of the fixed casing 120.

In the present embodiments, examples of mobile phone apparatuses to which the technology of the mobile terminal apparatus disclosed herein is applied have been described. However, the mobile terminal apparatus disclosed herein is not limited to the above-described embodiment. For example, the technology of the mobile terminal apparatus disclosed herein is also applicable to a variety of mobile terminals such as compact information processing terminals, compact music players, portable television sets, and portable game consoles.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions has been described in detail, it should be understood that various changes, substitutions, and alterations could be made hereto without departing from the spirit and scope of the invention.

What is claimed is:

1. A mobile terminal apparatus, comprising:
a first casing that is provided with an operation portion;
a second casing that is disposed so as to oppose a front surface of the first casing on which the operation portion is provided, the second casing being rotatable parallel to the front surface around a center positioned in a portion other than the operation portion of the front surface; and
a protruding portion that is formed between the operation portion and the center on a surface of either the first casing or the second casing, the surface with the protruding portion opposing the other casing, the protruding portion protrudes toward the other casing by a height greater than or equal to a gap provided between the casings at the center.

2. The mobile terminal apparatus according to claim 1,
wherein the second casing is provided with a rotating portion having a contact portion, the rotating portion rotating around the center substantially parallel to the front surface of the first casing together with the second casing in an integrated manner, the contacting portion contacting the protruding portion during the rotation, and
wherein the protruding portion is formed in a position corresponding to a path of the rotation of the contact portion on the surface of the first casing opposite the second casing.

3. The mobile terminal apparatus according to claim 2,
wherein the protruding portion protrudes by a height greater than or equal to the gap provided between the first casing and the second casing at the center, the protruding portion being formed so as to gradually decrease in height in directions from the center of the protruding portion to edges of the protruding portion.

4. The mobile terminal apparatus according to claim 2,
wherein the contact portion contacts the protruding portion along an entire range of the path of the rotation.
